(19) United States
(12) Patent Application Publication
(10) Pub. No.: US 2012/0082457 A1
(43) Pub. Date: Apr. 5, 2012

(54) K-Means Clustered Polyphase Filtering for Sample Rate Conversion in Coherent Polarization Multiplexing Fiber Optic Systems

(75) Inventors: Kai Yang, Princeton, NJ (US); Junqiang Hu, Davis, CA (US); Ting Wang, West Windsor, NJ (US)

(73) Assignee: NEC LABORATORIES AMERICA, INC., Princeton, NJ (US)

(21) Appl. No.: 12/894,742

(22) Filed: Sep. 30, 2010

(51) Int. Cl. H04J 14/06

(52) U.S. Cl. 398/65

(57) ABSTRACT

A method for clustered polyphase filtering input data converted from an optical signal converting input data from a serial form into a parallel form, permutating data symbols from the input data to form K clusters, passing the permutated data to an adder and multiplier for each cluster; and adding output of all K multipliers together to form an output.

### FIELD OF THE INVENTION

The present invention relates generally to optical communications, and more particularly, K-means clustered polyphase filtering in coherent polarization multiplexing fiber optic systems.

### BACKGROUND OF THE INVENTION

With the ever increasing demand for high-speed data transmissions (40 GB/S and beyond), polarization multiplexing (PolMux) fiber-optical systems with coherent detection have been the focus of constant attention. PolMux systems are able to transmit information bits through not only the amplitude but also the phase of a signal, thanks to the coherent detection techniques. Furthermore, advanced digital signal processing (DSP) technologies can be used to suppress major optical-channel distortions, such as the chromatic dispersion (CD) and polarization-mode dispersion (PMD).

The PolMux system uses high speed ADC to convert the received analog signal into a flow of digital values by sampling the analog signal periodically. We call the rate of sampled digital signals the sampling rate or sampling frequency. In order to facilitate the digital signal processing, the sampling rate is required to be twice or one and half of the symbol rate. However, in practice, the sampling frequency provided by a given ADC is pre-determined and can not be adjusted for different transmitted signals. As such, we need to convert the signal from one sampling frequency to another while changing the information carried over the signal as little as possible, which is called sample rate conversion

The combined up-sampling/down-sampling scheme is the most popular approach for the sample rate conversion, due to its simple structure and satisfying performance. The sample rate conversion is carried out in two stages, namely the up-sampling (expander) and down-sampling (decimator), as shown in FIG. 1. Assume we need to obtain new samples with rate U/D times of the original samples. Then we first insert U−1 zeros into every input sample to raise the data rate to be U times the original sampling rate. The obtained signal will pass a low-pass filter to remove the signal with frequencies higher than the cut-off frequency. After that, we discard D−1 samples out of every D samples and output the remaining samples.

Although the combined up-sampling/down-sampling approach provides a conceptually simple framework for the sample rate conversion, there exist two major challenges against the direct implementations. First, the data rate after the up-sampling stage, i.e., w(n), could be too high to be supported by the hardware. Furthermore, the complexity of the time domain convolution operation increases quickly with the length of h(r). To cope with these two challenges, Polyphase filtering has been proposed as an efficient approach for sample rate conversion. As shown in FIG. 2, the basic principle of the polyphase filtering is to divide the filter h(r) into U sub-filters with shorter length, and let the original data passes each sub-filter independently. In addition, due to the down-sampling operation, at most one sub-filter needs to work at a specific time slot, which considerably simplifies the system. However, even with all these simplifications, the traditional polyphase filtering method could still be difficult to implement in practice, mainly due to the extremely high data rate of the fiber-optical system.

### SUMMARY OF THE INVENTION

In one aspect of the invention, a method for clustered polyphase filtering input data converted from an optical signal converting input data from a serial form into a parallel form, permutating data symbols from the input data to form K clusters, passing the permutated data to an adder and multiplier for each cluster; and adding output of all K multipliers together to form an output.

In an alternative aspect of the invention, a method for clustered polyphase filtering input data converted from an optical signal includes clustering coefficients of a finite impulse response FIR filter into K groups; using a mean of each K group to approximate respective coefficients in the K groups; and reducing a number of multiplications for said FIR filter to K times.

### BRIEF DESCRIPTION OF DRAWINGS

These and other advantages of the invention will be apparent to those of ordinary skill in the art by reference to the following detailed description and the accompanying drawings.

FIG. 1 is a diagram showing sample rate conversion according to the prior art.

FIG. 2 is a diagram showing polyphase filter for sample rate conversion according to the prior art.

FIG. 3 is a graph showing tradeoff between the signal-to-noise-ratio SNR and the number of distinct finite-impulse-response FIR taps.

FIG. 4 is a graph illustrating the performance of K-means clustered polyphase filtering in accordance with the invention. For the graph of FIG. 4, the ADC sampling rate is 40 GSPS, desired sampling signal is at 28 GSPS, we have U=7, D=10, and 28=40* 7/10

FIG. 5 is a block diagram of a polarization multiplexing (PolMux) fiber-optical system employing K-means clustered polyphase filtering, in accordance with the invention.

FIG. 6 I a diagram of permutation of mapping inputs to outputs for the K-means clustering of FIG. 5.

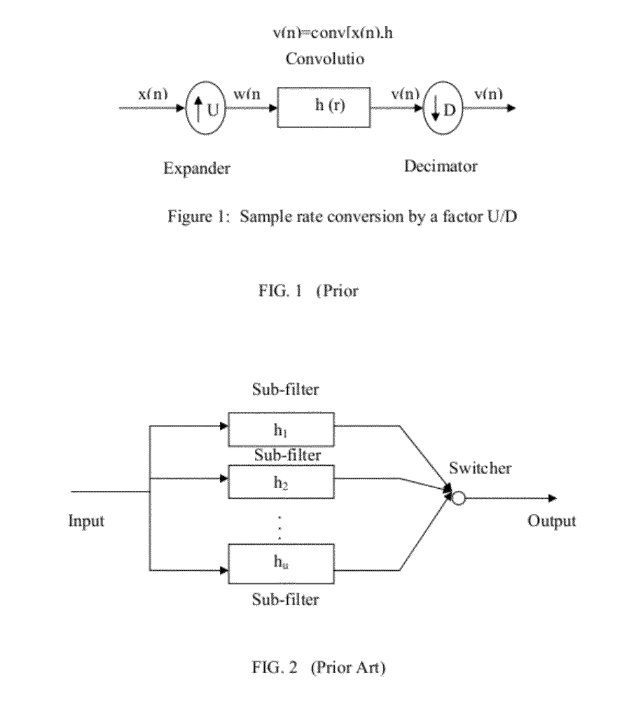

### DETAILED DESCRIPTION

The invention is directed to a K-means clustered polyphase filtering approach to deal with high speed sample rate conversion in the PolMux systems with coherent detection. It is much simpler than the conventional Polyphase filtering approach. In particular, we cluster the coefficients of the polyphase filter into K categories, and use the mean of each cluster to approximate the coefficients inside each cluster.

By properly selecting the parameter K, the resulting K-means clustered polyphase filtering approach can significantly reduce the number of distinct coefficients of the polyphase filter and thereby decrease the number of multiplications with little performance loss. For example, as shown in FIG. 3, the original sample rate converter SRC filter (called FIR # 1) for a 7/10 sample rate conversion contains 240 filter taps, which can achieve around 58 dB SNR for the rate conversion. By clustering the filter coefficients into 24 groups, we can approximate the original filter by a FIR filter with 24 taps (called FIR # 2), which is one order of magnitude simpler than the FIR # 1 in terms of the number of filter taps. In addition, FIR # 2 can attain a SNR of around 50 dB, which is far above the SNR threshold in this case. We can further reduce the number of FIR taps to 13 (FIR #3) at the expense of SNR penalty.

The graph of FIG. 4 illustrates the performance of the proposed K-means clustered polyphase filter for a 7/10 sample rate conversion. A filter with 24 taps is used. It is seen that the proposed filtering approach can provide accurate re-sampling results.

The diagram shown in FIG. 5 illustrates use of the invention K-means clustered polyphase filtering. The optical signals first pass the optical hybrid block (200) influenced by a local oscillator LO 100 and then are converted into electronic signal by the photo-diodes (300). The resulting analog electrical signals are then digitized by an analog-to-digital-converter ADC (400), and pass through the clustered polyphase filtering for sample rate conversion (500). The obtained signal will be used for polarization mode dispersion PMD compensation (600), followed by frequency offset and phase noise mitigation (700). Data demodulation (800) would be done for the recovered signals on two original polarizations.

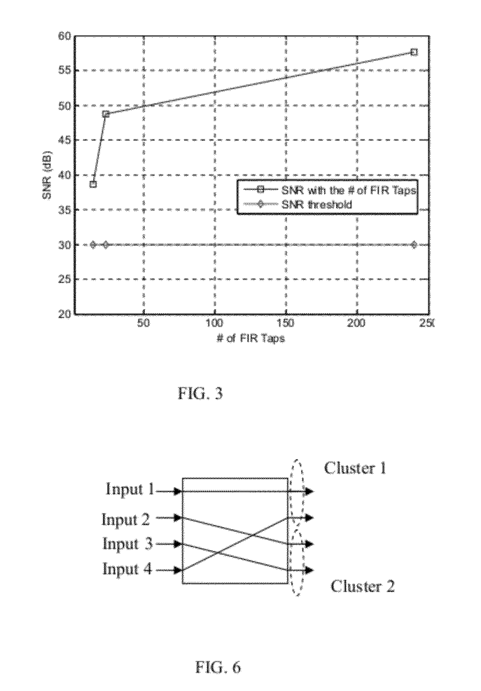

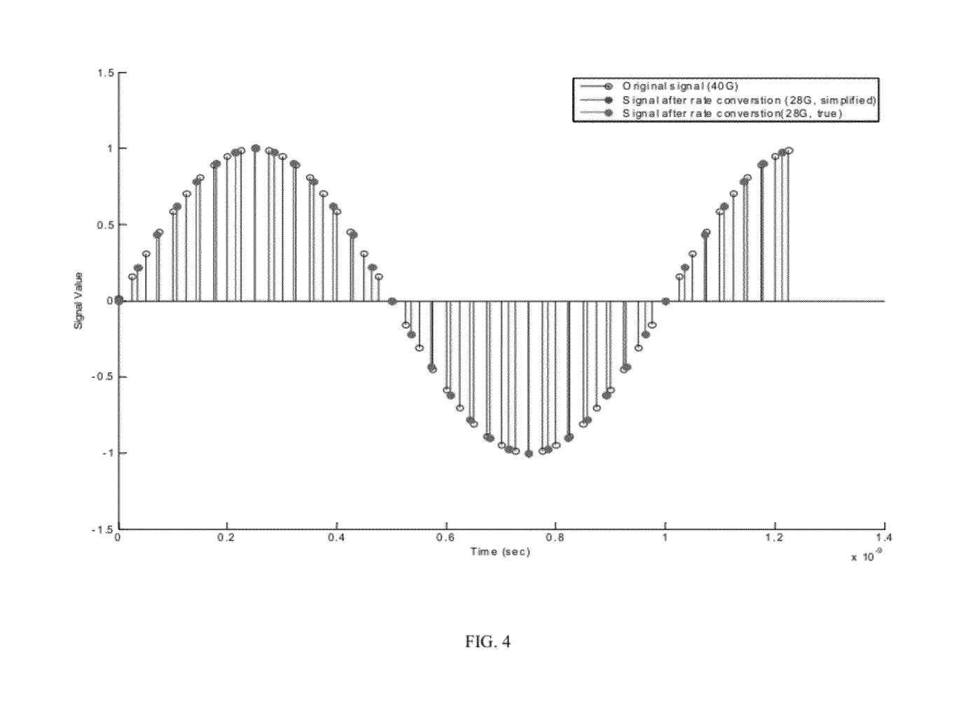

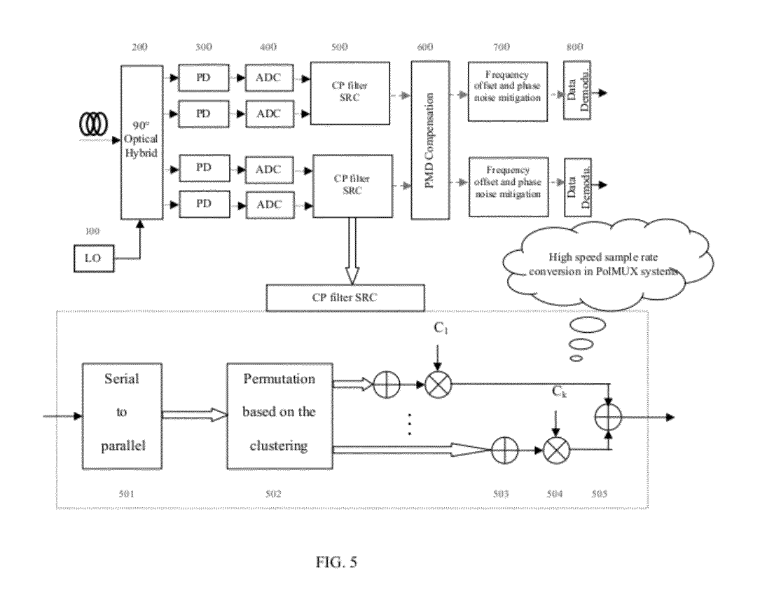

In the Clustered Polyphase filter 500, the input data will be first converted into parallel from serial form (501). The the data symbols will be permutated to form K clusters (502), and then pass to the adder (503) and multiplier (504) for each cluster. The output of all K multipliers will be added together (505) to form the final output. Notice, however, that in practice the permutation (502) can be easily achieved by the following functional block, as shown in FIG. 6, which does not require any extra computations. As shown by the diagram of FIG. 6, Input 1 and Input 4 are in the first cluster and Input 2 and Input 3 are in the second cluster.

The invention K-means clustered polyphase filtering described above provides significant advantages and benefits. The inventive technique clusters the coefficients of the SRC FIR filter into K groups and use the mean of each group to approximate the coefficients in that group. As such, the number of multiplications for this FIR filtering is reduced to K, which could be significantly smaller than the original length of the FIR filter. In practice, the number of K can be tuned to strike a balance between the performance and the complexity. Two critical aspects of the inventive filtering are: 1) the coefficients of the FIR filters are clustered into K groups according to their distances to each other and use the mean of each group to approximate any coefficients in that filter, and 2) when perform the filtering, all variables within same cluster and added up together and then be multiplied with corresponding coefficient (501-505) in FIG. 5

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. A method for clustered polyphase filtering input data converted from an optical signal, said method comprising the steps of:
converting input data from a serial form into a parallel;
permutating data symbols from said input data to form K clusters;
passing the permutated data to an adder and multiplier for each said cluster; and
adding output of all K said multipliers together to form an output.

2. The method of claim 1, wherein said step of permutating comprises mapping inputs to outputs.

3. The method of claim 2, wherein said step of passing comprises all variables with a same cluster being added up together and then multiplied with a respective coefficient.

4. The method of claim 1, wherein said passing step comprising clustering coefficients into said K of groups and using the mean of each group for approximating coefficients of said respective groups.

5. The method of claim 1, wherein said multiplier comprises a number of multiplications for filter being reduced to said K times.

6. A method for clustered polyphase filtering input data converted from an optical signal, said method comprising the steps of:
clustering coefficients of a finite impulse response FIR filter into K groups;
using a mean of each group to approximate respective coefficients in said K groups;
and reducing a number of multiplications for said FIR filter to K times.

7. The method of claim 6, wherein said K times is smaller than an original length of said filter.

8. The method of claim 6, wherein said step of clustering comprises clustering said coefficients into said K groups according to their distances.

9. The method of claim 7, wherein said step of using a mean comprises using a mean of each said K group to approximate any coefficients in said filter.
